(19) United States
(12) Patent Application Publication
(10) Pub. No.: US 2026/0002093 A1
(43) Pub. Date: Jan. 1, 2026

(54) Concentrated Liquid Rinse Aid Suitable for Dilution And Repeated Use

(71) Applicant: Reckitt Benckiser Finish B.V., Hoofddorp (NL)

(72) Inventors: Souhila AISSANI, Heidelberg (DE); Álvaro ANDREU NAVARRO, Heidelberg (DE); Frank DIERKES, Heidelberg (DE); Bettina MIKSCHL, Heidelberg (DE); Brigitte SANDMANN, Heidelberg (DE)

(21) Appl. No.: 18/874,836

(22) PCT Filed: Jun. 15, 2023
(86) PCT No.: PCT/EP2023/066074

§ 371 Date: Dec. 13, 2024

(30) Foreign Application Priority Data
Jun. 20, 2022 (GB) 2209008.8

(51) Int. Cl. C11D 1/722; C11D 1/38; C11D 3/34

(52) U.S. Cl. CPC C11D 1/722; C11D 1/38; C11D 3/3418; C11D 2111/16; C11D 2111/18

(57) ABSTRACT

Concentrated liquid rinse aid formulations for automatic dishwashing applications are disclosed comprising a surfactant mixture of an ethoxylated and propoxylated C₁₂ to C₁₈ linear alcohol and an ethoxylated C₁₂ to C₁₅ branched alcohol, wherein the minimum amount of the surfactant mixture in the concentrated liquid rinse aid formulation is at least approximately 30 wt %.

### TECHNICAL FIELD

Concentrated liquid rinse aid formulations for automatic dishwashing applications are disclosed comprising a surfactant mixture of an ethoxylated and propoxylated C₁₂ to C₁₈ linear alcohol and an ethoxylated C₁₂ to C₁₅ branched alcohol, wherein the minimum amount of the surfactant mixture in the concentrated liquid rinse aid formulation is at least approximately 30 wt %.

### BACKGROUND

One of the major concerns coming from consumers is to find wet dishes upon opening the dishwashing door when the dishwashing process has ended. Emptying the load and drying each item using a towel is a non-desired, time-consuming activity.

U.S. Pat. No. 5,273,677 to Arif discloses a rinse aid composition and a rinse aid concentrate which comprises an aqueous solution of a low foam surfactant, a solubilizing system for the low foam surfactant, and an anionic dispersing agent. Abstract.

European Patent Application Number 2963100 to Kolb Distribution Ltd discloses a liquid rinse aid composition comprising a blend of two non-ionic surfactants having simultaneously good rinsing, drying, streak-free, anti-filming and anti-spotting performance on substrates and also showing compared to the state of the art a superior water run-off behaviour. Abstract.

Another consumer concern is sustainability. Consumers are looking for products that use less plastics and water and create less CO₂.

A need remains for rinse aids that address these concerns.

### BRIEF SUMMARY

Concentrated liquid rinse aid formulations are disclosed comprising a surfactant mixture comprising, consisting essentially of, or consisting of (a) an ethoxylated and propoxylated C₁₂ to C₁₈ linear alcohol and (b) an ethoxylated C₁₂ to C₁₅ branched alcohol, wherein the minimum amount of the surfactant mixture in the concentrated liquid rinse aid formulation is at least approximately 30 wt %. The disclosed concentrated liquid rinse aid formulations may comprise one or more of the following aspects:
the surfactant mixture consisting essentially of (a) an ethoxylated and propoxylated C₁₂ to C₁₈ linear alcohol and (b) an ethoxylated C₁₂ to C₁₅ branched alcohol;
the surfactant mixture consisting of (a) an ethoxylated and propoxylated C₁₂ to C₁₈ linear alcohol and (b) an ethoxylated C₁₂ to C₁₅ branched alcohol;
the minimum amount of the surfactant mixture in the concentrated liquid rinse aid formulation being at least approximately 40 wt %;
the minimum amount of the surfactant mixture in the concentrated liquid rinse aid formulation being at least 40 wt %;
the minimum amount of the surfactant mixture in the concentrated liquid rinse aid formulation being at least approximately 50 wt %;
the minimum amount of the surfactant mixture in the concentrated liquid rinse aid formulation being at least 50 wt %;
the maximum amount of the surfactant mixture in the concentrated liquid rinse aid formulation being below approximately 60% wt;
the maximum amount of the surfactant mixture in the concentrated liquid rinse aid formulation being below 60% wt;
the maximum amount of the surfactant mixture in the concentrated liquid rinse aid formulation being below approximately 58% wt;
the maximum amount of the surfactant mixture in the concentrated liquid rinse aid formulation being below 58% wt;
the maximum amount of the surfactant mixture in the concentrated liquid rinse aid formulation being below approximately 55% wt;
the maximum amount of the surfactant mixture in the concentrated liquid rinse aid formulation being below 55% wt;
the ratio of (b):(a) ranges from approximately 1:1 to approximately 1:2;
the ratio of (b):(a) ranges from 1:1 to 1:2;
the concentration of (a) in the concentrated liquid rinse aid ranges from approximately 25% w/w to approximately 35% w/w;
the concentration of (a) in the concentrated liquid rinse aid ranges from 25% w/w to 35% w/w;
the ethoxylated and propoxylated C₁₂ to C₁₈ linear alcohol having a cloud point between approximately 20° C. and approximately 43° C. as measured in 1% water at 25° C.;
the ethoxylated and propoxylated C₁₂ to C₁₈ linear alcohol having a cloud point between 20° C. and 43° C. as measured in 1% water at 25° C.;
the ethoxylated and propoxylated C₁₂ to C₁₈ linear alcohol being a liquid at room temperature and pressure;
the ethoxylated and propoxylated C₁₂ to C₁₈ linear alcohol having a dynamic viscosity below approximately 100 cps at room temperature (23° C.);
the ethoxylated and propoxylated C₁₂ to C₁₈ linear alcohol having a dynamic viscosity below 100 cps at room temperature (23° C.);
the ethoxylated and propoxylated C₁₂ to C₁₈ linear alcohol being a polyoxyalkylene condensate surfactant;
the ethoxylated and propoxylated C₁₂ to C₁₈ linear alcohol being an alkoxylated predominantly unbranched fatty alcohol;
the ethoxylated and propoxylated C₁₂ to C₁₈ linear alcohol being a methyl-oxirane polymer with alkyl ether oxirane block surfactant;
the ethoxylated and propoxylated C₁₂ to C₁₈ linear alcohol having the Formula (I): R¹₂—C—O—[[EO]ₘ-[PO]ₙ]ₓ, wherein each R¹ is independently a C₁₂-C₁₈ alkyl group; m is 1-100, preferably 1-50, more preferably 1-29; n is 1-100, preferably 1-50, more preferably 1-29; and x is 1-100, preferably 1-50, more preferably 1-29. The EO and PO units may be random, alternating, block, or graft;
the ethoxylated and propoxylated C₁₂ to C₁₈ linear alcohol having the Formula (I): R¹₂—C—O-[[EO]ₘ-[PO]ₙ]ₓ, wherein each R¹ is independently a C₁₂-C₁₈ alkyl group; m is 1-10; n is 1-10; and x is 1-10 and the EO and PO units may be random, alternating, block, or graft;
the ethoxylated and propoxylated C₁₂ to C₁₈ linear alcohol having the Formula (II): Z—CH₂—CHZ—CH₂—[OCH₂—CHZ—CH₂]ₖ—Z, wherein k=2-29 and each Z is independently OH or R, provided that 4 to 25 percent of Z are R, with R being:
(a) —OCH₂—CHOH—CH₂—R′, with each R′ independently
   (i) a long chain alkyl radical containing 6 to 20 carbon atoms, or
   (ii) a polyoxyalkylene glycol ether radical —(CH₂—CHR″—O)ₚ—R″″, wherein each R″ is independently H, CH₃, or CH₂CH₃, p=3-20, and R′″ is a C₁-C₆ alkyl, with the average oxygen/carbon atom ratio of the radical being not greater than 0.4:1, or
(b) —O—(CH₂—CHR″—O)ₐ—CH₂—CHOH—CH₂—O—, wherein a=6-40 and R″ is defined in (a)(ii) above, with the average oxygen:carbon ratio of —(CH₂—CHR″—O)ₐ— being not greater than 0.4:1
wherein (a) constitutes one R and (b) constitutes two Rs in the same or different units of Formula (II);
the ethoxylated and propoxylated C₁₂ to C₁₈ linear alcohol being a combination of Formula (I) and Formula (II);
the ethoxylated and propoxylated C₁₂ to C₁₈ linear alcohol being a methyl-oxirane polymer with monoisotridecyl ether oxirane block surfactant sold under the trade name Plurafac™ LF-300 by BASF;
the ethoxylated C₁₂ to C₁₅ branched alcohol not being a Guerbet alcohol;
the concentration of the ethoxylated C₁₂ to C₁₅ branched alcohol in the concentrated liquid rinse aid ranging from approximately 20% w/w to approximately 30% w/w;
the concentration of the ethoxylated C₁₂ to C₁₅ branched alcohol in the concentrated liquid rinse aid ranging from 20% w/w to 30% w/w;
the ethoxylated C₁₂ to C₁₅ branched alcohol having an HLB value of approximately 10 to approximately 12;
the ethoxylated C₁₂ to C₁₅ branched alcohol having an HLB value of 10 to 12;
the ethoxylated C₁₂ to C₁₅ branched alcohol having an HLB value of approximately 11 to approximately 11.5;
the ethoxylated C₁₂ to C₁₅ branched alcohol having an HLB value of 11 to 11.5;
the ethoxylated C₁₂ to C₁₅ branched alcohol having an ethoxylation grade from 4 to 10;
the ethoxylated C₁₂ to C₁₅ branched alcohol being a liquid at room temperature and pressure;
the ethoxylated C₁₂ to C₁₅ branched alcohol having a viscosity below approximately 100 cps at room temperature (23° C.);
the ethoxylated C₁₂ to C₁₅ branched alcohol having a viscosity below 100 cps at room temperature (23° C.);
the ethoxylated C₁₂ to C₁₅ branched alcohol being an ethoxylated C₁₂-C₁₅ isoalcohol;
the ethoxylated C₁₂ to C₁₅ branched alcohol being an ethoxylated isotridecanol;
the formulation being a single phase liquid;
further comprising a hydrotrope;
the hydrotrope being sodium cumene sulfonate;
further comprising approximately 10% w/w to approximately 20% w/w hydrotrope;
further comprising 10% w/w to 20% w/w hydrotrope;
further comprising a material care agent;
the material care agent being zinc acetate dihydrate, a polymer, BTA, or combinations thereof;
the material care agent being a polymer;
the polymer being a pH independent cationic polymer with at least one quaternary group;
the pH independent cationic polymers having Formula (III): —(R—O—R—N⁺R₂X—R—NH—C(═O)—NH—R—N⁺R₂X—)ₙ, wherein each R is independently a C1-C4 alkyl group, n=1-1000, and X=halide, preferably Cl;
the pH independent cationic polymer being N,N′-bis[3-(dimethylamino)propyl]-urea polymer with 1,1′-oxybis[2-chloroethane]sold under the tradename Lugalvan P by BASF;
further comprising approximately 0.01% w/w to approximately 0.1% w/w polymer;
further comprising 0.01% w/w to 0.1% w/w polymer;
further comprising approximately 0.03% w/w to approximately 0.07% w/w polymer;
further comprising 0.03% w/w to 0.07% w/w polymer;
further comprising a pH adjuster;
wherein the pH adjuster is citric acid;
further comprising a preservative;
the preservative being potassium sorbate, 5-chloro-2-methyl-4-isothiazolin-3-one, 2-methyl-4-isothiazolin-3-one, or any combination thereof;
the preservative being 5-chloro-2-methyl-4-isothiazolin-3-one, 2-methyl-4-isothiazolin-3-one, or any combination thereof;
the concentrated liquid rinse aid being a single-phase liquid;
the concentrated liquid rinse aid being substantially free of sanitizing agent;
the concentrated liquid rinse aid being substantially free of anionic surfactant;
the concentrated liquid rinse aid being substantially free of percarboxylic acid;
the concentrated liquid rinse aid being substantially free of bleaching agent;
the concentrated liquid rinse aid being substantially free of monocarboxylic acid;
the concentrated liquid rinse aid being substantially free of enzyme;
the concentrated liquid rinse aid being substantially free of carbonate or bicarbonate;
the concentrated liquid rinse aid being substantially free of humectant;
the concentrated liquid rinse aid being substantially free of zinc salts;
the concentrated liquid rinse aid being substantially free of zinc acetate dihydrate;
the concentrated liquid rinse aid being substantially free of zinc chloride;
the concentrated liquid rinse aid being substantially free of alkali metal or alkaline earth metal salt of alkyl diphenyl oxide sulfonic acid; and/or
the concentrated liquid rinse aid not exhibiting precipitation after two weeks at 25° C.

Also disclosed are diluted liquid rinse aid products comprising one (1) part by volume of the concentrated liquid rinse aid formulations disclosed above and four (4) parts by volume of water. The disclosed diluted liquid rinse aid products may include one or more of the following aspects:
50 mL of the concentrated liquid rinse aid formulations produces 62.5 individual 4 mL doses of diluted liquid rinse aid when combined with 200 mL of water; or
80 mL of the concentrated liquid rinse aid produces 100 individual 4 mL doses of diluted liquid rinse aid when combined with 320 mL of water.

Also disclosed are methods of rinsing a hard surface in an automatic dishwashing machine. One (1) part by volume of any of the concentrated liquid rinse aid formulations disclosed above is added to four (4) parts by volume of tap water to produce a diluted liquid rinse formulation. The rinse aid compartment of the automatic dishwashing machine is filled with the diluted liquid rinse formulation. The automatic dishwashing machine is started. The disclosed methods may include one or more of the following aspects:
the hard surface being glass, ceramic, porcelain, plastic, stainless steel, or any combination thereof;
the hard surface being glass;
the hard surface being porcelain;
the hard surface being ceramic;
the hard surface being plastic;
the hard surface being stainless steel;
the method providing between 0 and 9 droplets of water on the hard surface;
the method providing less water droplets remaining on hard surfaces at the end of the dishwashing cycle as compared to the commercial formulations in the examples;
the method providing 3.5 or higher surface modifications on the hard surfaces after 25 repeated dishwashing cycles;
the method providing less cloudiness of the hard surfaces at the end of the dishwashing cycle as compared to the commercial formulations in the examples;
the method providing less spotting at the end of the dishwashing cycle as compared to the commercial formulations in the examples.

The above embodiments are exemplary only. Other embodiments as described herein are within the scope of the disclosed subject matter.

### Definitions

As used herein, the term “a” or “an” means one or more.

As used herein, the term “comprising” is inclusive or open-ended and does not exclude any additional elements; the term “consisting of” excludes any additional elements; and the term “consisting essentially of” is in-between, only permitting additional elements that do not materially affect characteristics of the product or process. For example, the surfactant mixture consisting essentially of the two non-ionic surfactants excludes any additional surfactants but may further include preservatives, impurities or solvents, such as water, lower C1-C4 alcohols, glycols, or glycol ethers.

As used herein, the term “approximately” or “about” means plus or minus 10 percent of the value stated.

As used herein, the w/w percent of an ingredient is based on the weight of the ingredient in grams in the total weight of the formulation in grams. When an ingredient does not contain close or equal to 100% active material, two percentages may be provided: one for the weight of the ingredient and one for the weight of the active. For example, 37.73 g of sodium cumene sulfonate contains approximately 40% of the active in water, which equates to approximately 15.09 g of sodium cumene sulfonate in the formulation. This would be represented as 37.73 g (15.09 g) of sodium cumene sulfonate.

As used herein, any and all ranges are inclusive of their endpoints. For example, a pH ranging from 10.5 to 11.2 would include formulations having a pH of 10.5, formulations having a pH of 11.2, and formulations having any pH between 10.5 and 11.2.

As used herein, the phrase “substantially free” means a concentration of less than 0.2 g/L, preferably less than 0.1 g/L, more preferably less than 0.05 g/L, and most preferably 0.001 g/L.

As used herein, the abbreviation EO refers to a repeating ethoxy group, also known as an ethylene oxide or oxirane group, represented by the formula —(O—CH₂—CH₂)—.

As used herein, the abbreviation PO refers to a repeating propoxy group, also known as a propylene oxide or methyl-oxirane group, represented by the formula —[O—CH(CH₃)—CH₂]—.

### DETAILED DESCRIPTION

Concentrated liquid rinse aid formulations are disclosed. The concentrated liquid rinse aid formulation comprises a surfactant mixture comprising (a) an ethoxylated and propoxylated C₁₂ to C₁₈ linear alcohol and (b) an ethoxylated C₁₂ to C₁₅ branched alcohol. Alternatively, the surfactant mixture consists essentially of (a) an ethoxylated and propoxylated C₁₂ to C₁₈ linear alcohol and (b) an ethoxylated C₁₂ to C₁₅ branched alcohol. In another alternative, the surfactant mixture consists of (a) an ethoxylated and propoxylated C₁₂ to C₁₈ linear alcohol and (b) an ethoxylated C₁₂ to C₁₅ branched alcohol.

The concentrated liquid rinse aid contains at least approximately 30% by weight of the surfactant mixture in the total weight of the concentrated liquid rinse aid formulation, preferably at least approximately 40% by weight, and more preferably at least approximately 50% by weight. The concentrated liquid rinse aid contains a maximum below approximately 60% weight of the surfactant mixture, preferably below approximately 58% weight, and more preferably below approximately 55% weight. In other words, the disclosed concentrated liquid rinse aid comprises between approximately 30% to approximately 60% by weight of the surfactant mixture, preferably between approximately 40% to approximately to approximately 58%, and more preferably between approximately 50% to approximately 55% by weight of the surfactant mixture.

The concentrated liquid rinse aid contains at least 30% by weight of the surfactant mixture in the total weight of the concentrated liquid rinse aid formulation, preferably at least 40% by weight, and more preferably at least 50% by weight. The concentrated liquid rinse aid contains a maximum below 60% weight of the surfactant mixture, preferably below 58% weight, and more preferably below 55% weight. In other words, the disclosed concentrated liquid rinse aid comprises between 30% to 60% by weight of the surfactant mixture, preferably between 40% to 58%, and more preferably between 50% to 55% by weight of the surfactant mixture.

As shown in the examples that follow, stability issues arise at this level of nonionic surfactant. Similarly, as demonstrated in U.S. Pat. No. 5,273,677, higher concentrations of nonionic surfactants require solubilizing systems in order to keep them in solution (col 4, lines 45-48, and examples). Applicant believes that the claimed combination of the linear and branched nonionic surfactants provide the molecular geometry needed to prevent precipitation in the concentrated liquid rinse aid formulation. Applicant similarly believes that an increased concentration of the combination of the linear nonionic surfactants in the rinse aid disclosed in European published patent application number 2,963,100 (i.e., reduction of water content) may exhibit similar stability issues as described in the examples as well as potential foaming issues. The carbon chain length and alkoxylation of each of the surfactants in the disclosed surfactant blend is selected to provide less foam than the shorter carbon chain nonionic surfactants disclosed in EP2963100. The carbon chain length and alkoxylation of each of the surfactants has also been selected to provide a suitable cloud point resulting in a transparent concentrated liquid rinse aid.

The amount of foaming increases as the concentration of the ethoxylated C₁₂ to C₁₅ branched alcohol increases. Therefore, while alternative weight ratios of the two surfactants may be stable as shown in Example 1 and suitable for formulations for different intended uses, the weight ratio of the (b) ethoxylated C₁₂ to C₁₅ branched alcohol to the (a) ethoxylated and propoxylated C₁₂ to C₁₈ linear alcohol in the surfactant mixture preferably ranges from approximately 1:1 to approximately 1:2, and more preferably from approximately 1:1 to approximately 1:1.5. Alternatively, the weight ratio of the (b) ethoxylated C₁₂ to C₁₅ branched alcohol to the (a) ethoxylated and propoxylated C₁₂ to C₁₈ linear alcohol in the surfactant mixture preferably ranges from 1:1 to 1:2, more preferably from 1:1 to 1:1.5.

Applicant believes that the combination of the ethoxylated and propoxylated C₁₂ to C₁₈ linear alcohol with the ethoxylated C₁₂ to C₁₅ branched alcohol decreases the surface tension of water more than either surfactant alone. The different sizes and properties of these surfactants may produce a more compact layer of the surfactant mixture on the surface of the substrate, which helps to decrease the surface tension of water and boost the sheeting effect of the disclosed rinse aids. This theory is confirmed in Example 2, which shows the improved drying index on glass and polypropylene surfaces for the claimed surfactant mixture compared to the ethoxylated and propoxylated C₁₂ to C₁₈ linear alcohol alone. These results are surprising over the disclosure in para 0036 of European Published Patent Application number 3,015,540, which states that Plurafac LF 300 exhibited longer drying times.

The ethoxylated and propoxylated C₁₂ to C₁₈ linear alcohol is a polyoxyalkylene condensate. The C₁₂ to C₁₈ linear fatty alcohol of the ethoxylated and propoxylated C₁₂ to C₁₈ linear alcohol is predominantly unbranched. The ethoxylated and propoxylated C₁₂ to C₁₈ linear alcohol is a liquid at room temperature and pressure. The ethoxylated and propoxylated C₁₂ to C₁₈ linear alcohol has a dynamic viscosity below 100 cps as measured by Brookfield LVT at room temperature (23° C.). The ethoxylated and propoxylated C₁₂ to C₁₈ linear alcohol has a cloud point between approximately 20° C. and approximately 43° C. as measured in 1% water at 25° C. Exemplary ethoxylated and propoxylated C₁₂ to C₁₈ linear alcohols suitable for use in the disclosed concentrated liquid rinse aid formulations may have the Formula (I): R¹₂—C—O-[[EO]ₘ-[PO]ₙ]ₓ,
wherein each R¹ is independently a C₁₂-C₁₈ alkyl group; m is 1-100, preferably 1-50, more preferably 1-29; n is 1-100, preferably 1-50, more preferably 1-29; and x is 1-100, preferably 1-50, more preferably 1-29. The EO and PO units may be random, alternating, block, or graft;
and/or Formula (II): Z—CH₂—CHZ—CH₂—[OCH₂—CHZ—CH₂]ₖ—Z,
wherein k=2-29 and each Z is independently OH or R, provided that 4 to 25 percent of Z are R, with R being:
   (a) —OCH₂—CHOH—CH₂—R′, with each R′ independently
      (i) a long chain alkyl radical containing 6 to 20 carbon atoms, or
      (ii) a polyoxyalkylene glycol ether radical —(CH₂—CHR″—O)ₚ—R″″, wherein each R″ is independently H, CH₃, or CH₂CH₃, p=3-20, and R′″ is a C₁-C₆ alkyl, with the average oxygen/carbon atom ratio of the radical being not greater than 0.4:1, or
   (b) —O—(CH₂—CHR″—O)ₐ—CH₂—CHOH—CH₂—O—, wherein a=6-40 and R″ is defined in (a)(ii) above, with the average oxygen:carbon ratio of —(CH₂—CHR″—O)ₐ— being not greater than 0.4:1
wherein (a) constitutes one R and (b) constitutes two Rs in the same or different units of Formula (II). One of ordinary skill in the art will recognize that the surfactant is a blend of closely related molecules with the carbon chain length, EO, and PO ranging within the defined number.

Exemplary ethoxylated and propoxylated C₁₂ to C₁₈ linear alcohols suitable for use in the disclosed concentrated liquid rinse aid formulations include but are not limited to methyl-oxirane polymers with alkyl ether oxirane block surfactants. Exemplary methyl-oxirane polymers with alkyl ether oxirane block surfactants include methyl-oxirane polymer with mono-octadecyl ether oxirane block, methyl-oxirane polymer with hexadecyl ether block, and/or methyl-oxirane polymer with monoisotridecyl ether oxirane block sold under the tradenames Plurafac™ LF-300 by BASF. Preferably, the ethoxylated and propoxylated C₁₂ to C₁₈ linear alcohol is methyl-oxirane polymer with monoisotridecyl ether oxirane block. The viscosity of one lot of Plurafac™ LF-300 measured at 23° C. using a Brookfield DV-II with spindle 27 had a viscosity of 0 mPas at 5 PRM, 0-25 mPas at 10 RPM, 25-37 mPas at 20 RPM, 50 mPas at 50 RPM, and 55 mPas at 100 RPM. The concentration in the liquid rinse aid formulation of the ethoxylated and propoxylated C₁₂ to C₁₈ linear alcohol ranges from approximately 25% w/w to approximately 35% w/w.

The ethoxylated C₁₂ to C₁₅ branched alcohol is not a Guerbet alcohol. The ethoxylated C₁₂ to C₁₅ branched alcohol is a liquid at room temperature and pressure. The ethoxylated C₁₂ to C₁₅ branched alcohol has a dynamic viscosity below 100 cps as measured by Brookfield LVT at room temperature (23° C.). The ethoxylated C₁₂ to C₁₅ branched alcohol has an HLB value ranging from 10 to 12, preferably from 11 to 11.5. The ethoxylated C₁₂ to C₁₅ branched alcohol has an ethoxylation grade from 4 to 10. Exemplary ethoxylated C₁₂ to C₁₅ branched alcohols suitable for use in the disclosed concentrated liquid rinse aid formulations include but are not limited to ethoxylated C₁₂ to C₁₅ isoalcohols, preferably ethoxylated isotridecanol. Ethoxylated isotrideconal having 6 EO is commercially available as Alfonic™ TDA-6 from Sasol or Lutensol™ TO 6 from BASF. One of ordinary skill in the art will recognize that the surfactant is a blend of closely related molecules with the carbon chain length and EO ranging within the defined number. The viscosity of one lot of Alfonic™ TDA-6 measured at 23° C. using a Brookfield DV-II with spindle 27 had a viscosity of 0 mPas at 5 PRM and 25-37 mPas at 20 RPM. The concentration in the liquid rinse aid formulation of the ethoxylated C₁₂ to C₁₅ branched alcohol ranges from approximately 20% w/w to approximately 30% w/w.

Stability of the disclosed concentrated liquid rinse aid formulations may be improved by including a polymer, preferably a pH independent cationic polymer with at least one quaternary group. Exemplary pH independent cationic polymers have Formula (III): —(R—O—R—N⁺R₂X—R—NH—C(═O)—NH—R—N⁺R₂X—)ₙ,
wherein each R is independently a C₁-C₄ alkyl group, n=1-1000, and X=halide, preferably Cl. Exemplary pH independent cationic polymers suitable for use in the disclosed concentrated liquid rinse aid formulation include polyquaternium-2, also known as N,N′-bis[3-(dimethylamino)propyl]-urea polymer with 1,1′-oxybis[2-chloroethane]. Polyquaternium-2 is commercially available from BASF under the tradename Lugalvan P or Mirapol™ 15 by Solvay. Only small amounts of the polymer are necessary in the formulation. The concentration of the polymer in the disclosed concentrated liquid rinse aid formulation ranges from approximately 0.03% to approximately 0.1% w/w, preferably from approximately 0.04% to approximately 0.08%. Alternatively, the concentration of the polymer in the disclosed concentrated liquid rinse aid formulation ranges from 0.03% to 0.1% w/w, preferably from 0.04% to 0.08%.

The polymer also serves as a material care ingredient, providing glass protection and minimizing corrosion. Alternative material care ingredients may be used in the disclosed concentrated liquid rinse aid formulations without departing from the teachings herein. For example, the material care ingredient may be selected from zinc salts, such as zinc chloride or zinc acetate; cationic polymers; benzotriazole (BTA); or any combination thereof. As disclosed in the examples that follow, 1.2% w/w zinc acetate dihydrate appears to affect the stability of the disclosed concentrated liquid rinse aid formulations. As a result, the disclosed concentrated liquid rinse aid formulations may be formulated with 0% w/w zinc salts, such as zinc chloride or zinc acetate dihydrate. Alternatively, further evaluation may reveal that lower concentrations of zinc salts or mixtures of zinc salts with other material care ingredients may not impact the stability of the disclosed concentrated liquid rinse aid formulations. For example, the disclosed concentrate liquid rinse aid formulations may comprise approximately 0.1% w/w to approximately 0.75% w/w zinc salts, preferably approximately 0.1% w/w to approximately 0.5% w/w, more preferably approximately 0.1% w/w to approximately 0.25% w/w. In another example, the disclosed concentrate liquid rinse aid formulations may comprise 0.1% w/w to 0.75% w/w zinc salts, preferably 0.1% w/w to 0.5% w/w, more preferably 0.1% w/w to 0.25% w/w.

The disclosed concentrated liquid rinse aid formulations may further include a hydrotrope. Hydrotropes are similar to surfactants, in that they have a hydrophilic part and a hydrophobic part. However, the hydrophobic part of a hydrotrope is too small to cause spontaneous self-aggregation associated with surfactant. As a result, hydrotrobes do not exhibit a crucial micelle concentration (cmc) or a critical vesicle concentration (csc) associated with surfactant activity. Exemplary hydrotropes include urea, tosylate, cumene sulfonate, and xylene sulfonate. Preferably, the hydrotrope is sodium cumene sulfonate or sodium xylene sulfonate. The disclosed concentrated liquid rinse aid formulation contains between approximately 10% w/w and approximately 20% w/w hydrotrope, preferably between approximately 12% w/w and approximately 18% w/w, and more preferably between approximately 14% w/w and approximately 16% w/w. Alternatively, the disclosed concentrated liquid rinse aid formulation contains between 10% w/w and 20% w/w hydrotrope, preferably between 12% w/w and 18% w/w, and more preferably between 14% w/w and 16% w/w.

The disclosed concentrated liquid rinse aid formulations may further include a pH adjuster to maintain the pH of the formulation between approximately 2 to approximately 4, preferably from 2 to 4, more preferably between approximately 2.5 and approximately 3.5, and most preferably from 2.5 to 3.5. Exemplary pH adjusters include acids, such as HCl, H₂SO₄, citric acid, lactic acid, sorbic acid, acetic acid, boric acid, formic acid, maleic acid, adipic acid, malic acid, malonic acid, glycolic acid, and mixtures thereof. Preferably, the pH adjuster has a pKa of approximately 3, such as acetic acid, ascorbic acid, benzoic acid, citric acid, or formic acid. Alternatively, the pH adjuster may be a buffer, such as citric acid and Na₂HPO₄, citric acid and sodium citrate, sodium acetate and acetic acid, or combinations thereof. Preferably, a small amount (e.g., between 5-6% w/w) of citric acid is used as the pH adjuster because higher amounts produce spots on glasses. Because the pH of the formulation is low, the disclosed concentrated liquid rinse aid formulations is substantially free of any carbonates or bicarbonates, which increase the pH of the formulation. Additionally, the carbonates/bicarbonates may react with the pH adjuster to form bubbles, which is not desired.

The disclosed concentrated liquid rinse aid formulations may further include a preservative. Exemplary preservatives include sodium benzoate, sodium formate, benzyl alcohol, formic acid, potassium sorbate, isothiazolinones such as 5-chloro-2-methyl-4-isothiazolin-3-one and/or 2-methyl-4-isothiazolin-3-one, or any combination thereof. The combination of 5-chloro-2-methyl-4-isothiazolin-3-one and/or 2-methyl-4-isothiazolin-3-one are more effective at the acidic pH of the disclosed concentrated liquid rinse aid formulations.

The disclosed concentrated liquid rinse aid formulation is a transparent, single-phase solution. Synthesis of a single-phase solution is quicker and easier than synthesis of emulsions or suspensions. Stability is also easier to maintain for single-phase solutions than for alternative liquid formulations. Mixing the liquid rinse aid formulation with water occurs more quickly than mixing a concentrated powder or tablet formulation.

The disclosed concentrated liquid rinse aid formulation is substantially free of any sanitizing agents. One of ordinary skill in the art would recognize that the dishwashing detergent as well as the temperature of the dishwashing process removes the need for any further sanitization or whitening during the rinse cycle. As a result, the disclosed concentrated liquid rinse aid formulation is substantially free of bleaching agents, such as hydrogen peroxide, percarboxylic acids, TAED, or manganese salt catalyst.

Similarly, as the disclosed concentrated liquid rinse aid formulation is utilized during the rinse cycle, the disclosed concentrated liquid rinse aid formulation is substantially free of enzymes or monocarboxylic acids used to break down organic molecules and loosen particles on the dishware.

The disclosed concentrated liquid rinse aid formulations may be prepared by adding the solid materials to the liquid hydrotrope under mixing until dissolution. The liquid preservative and polymer are then sequentially added to the mixing formulation and blended until uniformity. The nonionic surfactants are then sequentially added to the mixing formulation and blended until uniformity, preferably with the larger quantity material being added prior to the smaller quantity material. Applicant has further noticed that the formulation remains clear when the ethoxylated and propoxylated C₁₂ to C₁₈ linear alcohol is added prior to the ethoxylated C₁₂ to C₁₅ branched alcohol. However, the inverse order may also be used without departing from the teachings herein because the formulation eventually regains clarity after mixing. Finally, the dye is added and mixed until uniformity. During the entire mixing process, the speed of the mixing should be controlled to produce a uniform solution, while simultaneously preventing foaming. One of ordinary skill in the art will recognize that the size of the mixing tank and propeller will determine the needed mixing speed. Similarly, heating may be used to help decrease mixing time, preferably between approximately 25° C. to approximately 40° C.

The disclosed concentrated liquid rinse aid formulations may be used to rinse a hard surface in an automatic dishwashing machine. One (1) part by volume of the concentrated liquid rinse aid formulation is added to four (4) parts by volume of tap water to produce a diluted liquid rinse formulation. As the concentrated liquid rinse aid formulation is substantially free of any charged surfactants, such as cationic or anionic surfactants, the hardness of the water has little impact on the performance of the resulting diluted liquid rinse formulation. The rinse aid compartment of the automatic dishwashing machine is filled with the diluted liquid rinse formulation and started. The rinsing method may be used on such hard surfaces as glass, porcelain, ceramic, plastic, stainless steel, any other cutlery or tableware materials, and combinations thereof.

The disclosed concentrated liquid rinse aid formulations utilize smaller packaging than standard rinse aids, resulting in less plastic usage and less expensive shipping costs. Preferably, the disclosed concentrated liquid rinse aid formulation is shipped in a container adapted to mate with the threaded neck of a bottle. The bottle may contain a fill line indicating the amount of water needed for dilution of the disclosed concentrated liquid rinse aid formulations. Water is added to the fill line and the container is then screwed onto the threaded neck of the bottle. In a preferred embodiment, the container includes a sealing mechanism that releases the bottle's contents after the container and bottle mate, permitting easy transfer of the disclosed concentrated liquid rinse aid formulation. Exemplary containers include those described in U.S. Pat. No. 11,198,546 or US Pat App Pub No 2022/0002045, both to BNOVA SA, the contents of which are both incorporated by reference herein in their entireties. Alternatively, the container may include a dispensing nozzle that permits the disclosed concentrated liquid rinse aid to be transferred from its packaging container to a bottle suitable for dilution. In another alternative, the container may include a standard cap.

The disclosed concentrated liquid rinse aid formulations also provide more doses of rinse aid than conventional liquid rinse aid packaging. Consumers will achieve the same or better rinse aid performance using a compact starting material capable of rinse aid which is efficient and can be diluted 1:4 which delivers better spotting and drying performance than current formulations. For example, 50 mL of the concentrated liquid rinse aid formulations produces 62.5 individual 4 mL doses of diluted liquid rinse aid when combined with 200 mL of water and 80 mL of the concentrated liquid rinse aid produces 100 individual 4 mL doses of diluted liquid rinse aid when combined with 320 mL of water. When the diluted liquid rinse aid products are used in the rinse cycle of a dishwasher, the hard surfaces have between 00 and 9 droplets of water. This is less water droplets remaining on hard surfaces at the end of the dishwashing cycle as compared to the commercial formulations in the examples. When the diluted liquid rinse aid products are used in the rinse cycle of a dishwasher, the hard surfaces have 3.5 or higher surface modification after 25 repeated dishwashing cycles. When the diluted liquid rinse aid products are used in the rinse cycle of a dishwasher, the hard surfaces have less spotting and are less cloudy at the end of the dishwashing cycle as compared to the commercial formulations in the examples.

The following example below illustrates exemplary embodiments of the invention. It is to be understood that these examples are provided by way of illustration only and that further embodiments may be produced in accordance with the teachings of the present invention.

### EXAMPLES

The formulations in the following examples were prepared using the ingredients identified in Table A:

TABLE A

| Abbreviation | CAS | Description |
|---|---|---|
| H₂O | 7732-18-5 | Deionized Water |
| SCS | 28348-53-0 | Sodium Cumene Sulfonate (40% w/w in water) |
| KS | 24634-61-5 | Potassium sorbate |
| CIT/MIT | 26172-55-4 & | Aqueous mixture of 3% w/w 5-chloro-2-methyl-4- |
| | 2682-20-4 | isothiazolin-3-one and 1% w/w 2-methyl-4- |
| | | isothiazolin-3-one, e.g., sold under the |
| | | tradename Acticide ™ MV by Thor |
| CA | 77-92-9 | Citric acid anhydrous |
| LF300 | 196823-11-7 | Oxirane, methyl-, polymer with oxirane, |
| | | monoisotridecyl ether, block, e.g., sold under |
| | | the tradename Plurafac ™ LF 300 by BASF |
| ZA | 5970-45-6 | Zinc Acetate Dihydrate (97%) |
| D | Various | Dye (1% w/w in water) |
| PPG | 57-55-6 | Propylene Glycol |
| EtOH | 64-17-5 | Ethanol (80-100%, sometimes contains denaturant) |
| DTPM | 25498-49-1 | Tripropylene glycol methyl ether, e.g., sold under |
| | | the trade name Dowanol ™ TPM by Dow (>98.5%) |
| DPnB | 5131-66-8 | Propylene glycol n-butyl ether, e.g., sold under |
| | | the trade name Dowanol ™ PnB by Dow (>97.5%) |
| TDA6 | 69011-36-5 | Ethoxylated isotridecanol having 6 moles |
| | | ethoxylate, e.g., sold under the tradename |
| | | Alfonic ™ TDA-6 by Sasol or Lutensol ™ |
| | | TO 6 by BASF |
| GEP | 120313-48-6 | Fatty alcohol alkoxylate, sold under the tradename |
| | | Genapol ™ EP2584 by Clariant |
| LP | 68555-36-2 | Urea, N,N′-bis[3-dimethylamino)propyl]-, |
| | | polymer with 1,1′-oxybis[2-chloroethane], |
| | | also known as polyquaternium-2, sold under |
| | | the tradename Lugalvan ™ P by BASF (65%) |

### Comparative Example 1

Initial testing was performed using Applicant's current commercial formulation as a starting point. Applicant hoped that removing water from the commercial formulation would provide a concentrated and eco-friendly solution. Unfortunately, formulation A shown in Table 1a below precipitated at 400 W and 5000 after three (3) days. Additional and alternative solvents were included in formulations B through L in Tables 1a and 1b below to try to maintain the precipitates in solution, with no success. Formulations B through L also exhibited precipitation over time. Alternative non-ionic surfactants were also tested alone in Formula 0 or in combination with the existing nonionic in Formulations M and N, but the concentrated formulations remained unstable. One of ordinary skill in the art will recognize that liquid crystal formation may occur at such high nonionic surfactant concentration levels.

TABLE 1a

| | % Weight in | | | | | | | |
|---|---|---|---|---|---|---|---|---|
| Raw | Commercial | % Wt | % Wt | % Wt | % Wt | % Wt | % Wt | % Wt |
| Material | Formulation | A | B | C | D | E | F | G |
| H₂O | 80.308 | 0 | 0 | 0 | 0 | 0 | 0 | 0 |
| SCS | 7.5 | 37.3 (14.9) | 22.4 (8.96) | 0 | 27.44 (10.98) | 27.44 (10.98) | 27.44 (10.98) | 36.8 (14.7) |
| KS | 0.1 | 0.5 | 0.5 | 0.5 | 0.5 | 0.5 | 0.5 | 0.5 |
| CIT/MIT* | 0.08 | 0.08 | 0.08 | 0.08 | 0.08 | 0.08 | 0.08 | 0.08 |
| CA | 0.83 | 5.22 | 5.22 | 5.22 | 5.22 | 5.22 | 5.22 | 5.22 |
| LF300 | 11 | 54.7 | 54.7 | 54.7 | 54.7 | 54.7 | 54.7 | 54.7 |
| ZA | 0.18 | 1.2 | 1.2 | 1.2 | 1.2 | 1.2 | 1.2 | 1.2 |
| D | 0.002 | 1 (0.01) | 1 (0.01) | 1 (0.01) | 1 (0.01) | 1 (0.01) | 1 (0.01) | 1 (0.01) |
| PPG | 0 | 0 | 14.3 | 34.3 | 6.86 | 0 | 0 | 0 |
| EtOH | 0 | 0 | 0 | 3 | 3 | 3 | 3 | 0.5 |
| DTNP | 0 | 0 | 0 | 0 | 0 | 6.86 | 0 | |
| DPNB | 0 | 0 | 0 | 0 | 0 | 0 | 6.86 | |

*0.08% CIT/MIT raw material = 0.0024% CIT and 0.0008% MIT active levels

TABLE 1b

| Raw | % Wt | % Wt | % Wt | % Wt | % Wt | % Wt | % Wt | % Wt | % Wt |
|---|---|---|---|---|---|---|---|---|---|
| Material | H | I | J | K | L | M | N | O | P |
| H₂O | 0 | 0 | 3 | 6 | 10 | 0 | 0 | 0 | 0 |
| SCS | 36.3 (14.5) | 35.3 (14.1) | 34.3 (13.7) | 31.3 (12.5) | 27.3 (10.9) | 37.3 (14.9) | 37.3 (14.9) | 37.3 (14.9) | 37.73 (14.9) |
| KS | 0.5 | 0.5 | 0.5 | 0.5 | 0.5 | 0.5 | 0.5 | 0.5 | 0.5 |
| CIT/MIT* | 0.08 | 0.08 | 0.08 | 0.08 | 0.08 | 0.08 | 0.08 | 0.08 | 0.08 |
| CA | 5.22 | 5.22 | 5.22 | 5.22 | 5.22 | 5.22 | 5.22 | 5.22 | 5.28 |
| LF300 | 54.7 | 54.7 | 54.7 | 54.7 | 54.7 | 27.35 | 13.675 | 0 | 0 |
| ZA | 1.2 | 1.2 | 1.2 | 1.2 | 1.2 | 1.2 | 1.2 | 1.2 | 0 |
| D | 1 (0.01) | 1 (0.01) | 1 (0.01) | 1 (0.01) | 1 (0.01) | 1 (0.01) | 1 (0.01) | 1 (0.01) | 1 (0.01) |
| EtOH | 1 | 2 | 0 | 0 | 0 | 0 | 0 | 0 | 0 |
| TDA6 | 0 | 0 | 0 | 0 | 0 | 27.35 | 41.025 | 54.7 | 0 |
| GEP | 0 | 0 | 0 | 0 | 0 | 0 | 0 | 0 | 55.33 |
| LP | 0 | 0 | 0 | 0 | 0 | 0 | 0 | 0 | 0.07 (0.05) |

*0.08% CIT/MIT raw material = 0.0024% CIT and 0.0008% MIT active levels

### Comparative Example 2

Instead of a concentrated liquid rinse aid, Applicant also contemplated formulating a tablet rinse aid. However, the concentration needed to achieve the desired results are not commercially feasible because the required tablet size is too large. The current liquid rinse aid dispensing bottle has a 1.5 cm neck opening. A 250 mL rinse aid bottle having this 1.5 cm neck opening would require two (2) 14.1 cm long×1.5 cm wide×1.5 cm deep tablets. The same 250 mL rinse aid bottle would require eight (8) 3.55 cm long×1.5 cm wide×1.5 cm deep tablets. The same 250 mL rinse aid bottle would require 29 balls having a 1.5 cm diameter. Increasing the size of the neck opening in order to make larger tablets would result in the use of more plastic in the bottle, which defeats the eco-friendly goals of the present invention. These tablets would also take time to dissolve. As a result, the disclosed concentrated rinse aid formulations must be supplied in liquid form.

### Example 1: Stability

The following exemplary formulations were prepared and underwent stability testing at 5° C. with 50% relative humidity (RH), uncontrolled room temperature, 40° C. with 75% RH, and/or 50° C. with uncontrolled humidity for up to six (6) weeks, or less if problems were detected. None of the formulations exhibited any precipitation.

The exemplary formulations were prepared by sequentially adding the KS and CA to the SCS under mixing until dissolution. The CIT/MIT and LP were then sequentially added to the mixing formulation and blended until uniformity. The LF300 and TDA6 were then sequentially added to the mixing formulation and blended until uniformity. Finally the D was added and mixed until uniformity. During the entire mixing process, the speed of the mixing was controlled to produce a uniform solution, while simultaneously preventing foaming.

As shown in the following examples, the formulations provide improved results compared to both commercially available formulations and test formulations containing a single non-ionic surfactant.

TABLE 2

| Raw | % Wt | % Wt | % Wt | % Wt |
|---|---|---|---|---|
| Material | Q | R | S | T |
| SCS | 37.73 (15.1) | 37.73 (15.1) | 37.73 (15.1) | 37.73 (15.1) |
| KS | 0.5 | 0.5 | 0.5 | 0.5 |
| CIT/MIT* | 0.08 | 0.08 | 0.08 | 0.08 |
| CA | 5.28 | 5.28 | 5.28 | 5.28 |
| LF300 | 27.665 | 38.73 | 13.83 | 30.43 |
| TDA6 | 27.665 | 16.599 | 41.50 | 24.9 |
| LP | 0.07 (0.05) | 0.07 (0.05) | 0.07 (0.05) | 0.07 (0.05) |
| D | 1.01 (0.01) | 1.01 (0.01) | 1.01 (0.01) | 1.01 (0.01) |

*0.08% CIT/MIT raw material = 0.0024% CIT and 0.0008% MIT active levels

### Example 2: Dry Performance Testing in Dishwasher

Dry performance testing was performed using formulations Q and T from Table 2 above compared to the formulations provided in Table 3 below. U is a commercially available rinse aid. 80 mL of V were diluted with 320 mL of tap water to produce 400 mL of the diluted liquid rinse aid product. 4 mL of the diluted liquid rinse aid product was added to the rinse aid compartment of the dishwasher used in this dry performance testing.

TABLE 3

| Raw | % Wt | % Wt |
|---|---|---|
| Material | U | V |
| H₂O | 79.9 | 0 |
| SCS | 7.5 | 37.73 |
| KS | 0.1 | 0.5 |
| CIT/MIT* | 0.08 | 0.08 |
| CA | 0.98 | 5.28 |
| LF300 | 11 | 55.3 |
| LP | 0 | 0.07 (0.05) |
| D | 0.2 | 1.01 (0.01) |

For this purpose, a machine load consisting of glass, stainless steel, porcelain, and plastic was washed in a Bosch SMS46CW03E/41 dishwasher in Eco 50° C. program without Vario Speed and with 9 German Hardness water. The plastic included polypropylene, polyethylene, melamine, and styrene-acrylonitrile copolymer (SAN). No ballast soil was added. A commercially available automatic dishwashing tablet which does not contain any rinse aid formulation was used for the wash cycle. At the beginning of the final drying step, the dishwasher was opened to manually add 4 mL of the rinse aid formulations using a pipette.

The drying index was determined 30 minutes after the end of the complete dishwashing program. The door of the dishwasher was kept closed during these 30 minutes. The maximum score for ideal drying is 1, the worst score is 0. The reported value represents the average of three trials. The results are provided in Table 4:

TABLE 4

| | Glass | Stainless Steel | Porcelain | Plastic |
|---|---|---|---|---|
| Q | 0.94 | 0.99 | 0.77 | 0.26 |
| T | 0.86 | 0.99 | 0.74 | 0.26 |
| U | 0.72 | 0.98 | 0.75 | 0.16 |
| V | 0.69 | 0.99 | 0.68 | 0.15 |

As shown in Table 4, Exemplary Formulations Q and T provide superior drying efficacy on glass and plastic as compared to the commercial formulation U and a formulation containing only one nonionic surfactant V. Exemplary Formulations Q and T also provide superior drying efficacy on porcelain as compared to formulation V's one nonionic surfactant. Formulations Q, T, U, and V all exhibit similar drying performance on stainless steel.

Stability testing was performed on formulation V. Precipitation was observed after 3 weeks at 5° C. This demonstrates that replacing ZA with LP is not solely responsible for the stability of the disclosed concentrated liquid rinse aid formulations, particularly when only one nonionic surfactant is included in the concentrated liquid rinse aid formulation.

### Example 3: Dry Performance Testing—Water Drop Counting

A new drying method was developed based on water drop counting to permit a better discrimination between samples. Formulation T was tested against a commercial multi-benefit detergent formulation W, with the ingredients provide in Table 5 below alongside commercial multi-benefit detergent formulation X used in Example 4 below. The listing of ingredients in these commercially available formulations was obtained from the manufacturer's website.

TABLE 5

| | W | X |
|---|---|---|
| Ceteareth-25 | — | ✓ |
| Fatty Alcohol Alkoxylate | ✓ | ✓ |
| Modified fatty alcohol polyglycolether | — | ✓ |
| Dodecylbenzene sulfonic acid | — | ✓ |
| Sodium Carbonate Peroxohydrate | ✓ | — |
| Trisodium dicarboxymethyl alaninate | ✓ | — |
| Pentasodium triphosphate | — | ✓ |
| 6-phthalimidohexaneperoxoic acid | — | ✓ |
| Tetraacetylethylenediamine (TAED) | ✓ | — |
| 1,4,7-trimethyl-1,4,7-triazacyclononane (MnTACN) | ✓ | — |
| 1,3-dihydro-1,3-dioxo-2H-isoindole-2-hexanoic acid | — | ✓ |
| Tetrasodium Etidronate | ✓ | ✓ |
| Disodium Etidronate | — | ✓ |
| Methylglycine diacetic acid sodium salt | — | ✓ |
| Polyvinyl Alcohol | ✓ | — |
| 2-propenoic acid, homopolymer, sodium salt, sulfonated | ✓ | ✓ |
| Sodium polyacrylate | — | ✓ |
| Ethylene/propylene oxide copolymer | ✓ | — |
| Acrylic acid maleic acid copolymer | ✓ | — |
| Maleic-, acrylic acid copolymer sodium salt | ✓ | — |
| Polyquaternium-2 | ✓ | — |
| Calcium Carbonate | ✓ | — |
| Sodium Carbonate | ✓ | ✓ |
| Sodium Citrate | ✓ | — |
| Sodium Sulfate | ✓ | ✓ |
| Sodium Silicate | ✓ | ✓ |
| Sodium Silicoaluminate | — | ✓ |
| Silica | — | ✓ |
| 1-H-methylbenzotriazole | ✓ | ✓ |
| Titanium dioxide | ✓ | — |
| Amylase | ✓ | ✓ |
| Protease | — | ✓ |
| Subtilisin | ✓ | — |
| Cellulose | ✓ | ✓ |
| Dextrin | ✓ | — |
| Oryza Sativa | — | ✓ |
| Sucrose | — | ✓ |
| Kaolin | ✓ | — |
| Dimethicone | ✓ | ✓ |
| Glycerol | — | ✓ |
| Polyethylene Glycol | ✓ | — |
| PEG-90 | — | ✓ |
| Propylene Glycol | ✓ | — |
| Limonene | ✓ | — |
| Perfume | ✓ | ✓ |
| Colorant | ✓ | — |
| H₂O | ✓ | ✓ |
| Thermal shrinkable PVOH film | — | ✓ |

The dry performance was assessed by running one dishwashing cycle in a Bosch SMS6ECW57E/10 dishwasher in Eco 50° C. program with Speed Perfect Plus and with 21 German Hardness water. The dishwasher contained standard dish items. Ballast soil was added to the dish items to mimic consumer relevant conditions. The ballast soil composition is based on a publication by Hubbuch et al., Amount and composition of soils in German dishwashers. Composition to standard test method. SÖFW Journal—Seifen Öle Fette Wachse, 125, 14-20, 1999. At the beginning of the final drying step, the dishwasher was opened to manually add 4 mL of the rinse aid formulations using a pipette. The drying score was determined 15 minutes after the end of the complete dishwashing program. Evaluation is based on counting droplets on the dish items, with 0=no droplets through 9=nine droplets and 10=10 or more droplets. This evaluation scheme is based on the published drying performance method (the so-called Cognis method), with the scale being extended to 10. The results are provided in Table 6:

TABLE 6

| | Glass | Stainless Steel | Porcelain | Plastic | Total |
|---|---|---|---|---|---|
| T | 2.1 | 0 | 0.5 | 2.2 | 1.2 |
| W | 4.6 | 1.5 | 1.6 | 8.9 | 4.2 |

As shown in Table 6, Exemplary formulation T provides superior drying efficacy on all tested surfaces as compared to the commercial multi-benefit detergent formulation W. This example demonstrates that the disclosed rinse aid exhibits better drying than formulations containing ingredients like bleaching agents, carbonates, enzymes, or humectants.

### Example 4: Shine Performance Testing—Spotting

A shine test was performed comparing a multi-benefit formulation X alone or combined with commercial rinse aid U or exemplary concentrated rinse aid T. The shine performance was assessed by running several consecutive dishwashing cycles in a commercial dishwasher containing standard dish items. Ballast soil was added to the dish items to mimic consumer relevant conditions. Evaluation of the dish item was based on a five (5) point scale, with 1 being the best and 5 being the worst. Two parameters were evaluated: 1) spotting (clear discrete spots) and 2) filming (no clear contrast, no border/limit, mainly covering the whole dish item). The results are provided in Table 7:

TABLE 7

| | Glass | Stainless Steel | Porcelain | Plastic |
|---|---|---|---|---|
| X + T | 2.0 | 2.0 | 2.0 | 5.0 |
| X + U | 3.4 | 2.0 | 3.5 | 5.0 |
| X | 3.8 | 2.0 | 3.5 | 5.0 |

As shown in Table 7, Exemplary formulation T provides superior shine on glass and porcelain as compared to the commercial multi-benefit detergent formulation X alone or combined with the commercial rinse aid U.

### Example 5: Glass Clouding

In order to verify the material care property of the disclosed concentrated rinse aid formulation, glass clouding was evaluated using the commercial multi-benefit detergent formulation W with or without formulation T. The results are provided in Table 8:

TABLE 8

| | 25 cycles | 50 cycles | 100 cycles |
|---|---|---|---|
| W + T | 3.6 | 3.1 | 2.5 |
| W | 3.0 | 2.5 | 2.0 |

As shown in Table 8, and taking into account that a higher score indicates better performance, Exemplary formulation T provides less glass clouding as compared to the commercial multi-benefit detergent Y alone.

The foregoing description of various aspects of the invention has been presented for purposes of illustration and description. Embodiments and/or features therein may be freely combined with one another. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A concentrated single phase liquid rinse aid comprising a surfactant mixture comprising:
(a) an ethoxylated and propoxylated C₁₂ to C₁₈ linear alcohol; and
(b) an ethoxylated C₁₂ to C₁₅ branched alcohol, and
wherein the concentrated liquid rinse aid contains at least 30 wt % of the surfactant mixture in the total weight of the concentrated liquid rinse aid.

2. The concentrated liquid rinse aid of claim 1, wherein the maximum amount of surfactants in the composition is below 60% wt.

3. The concentrated liquid rinse aid of claim 1, wherein the weight ratio of (b):(a) ranges from 1:1 to 1:2.

4. The concentrated liquid rinse aid of claim 1, wherein the concentration of (a) in the concentrated liquid rinse aid ranges from 25% w/w to 35% w/w.

5. The concentrated liquid rinse aid of claim 1, wherein (a) has a cloud point between 20° and 43° C. as measured in 1% water at 25° C.

6. The concentrated liquid rinse aid of claim 1, wherein (a) is a liquid at room temperature and pressure.

7. The concentrated liquid rinse aid of claim 1, wherein (a) is a polyoxyalkylene condensate surfactant having a formula selected from:
a) Formula (I): R¹₂—C—O—[[EO]ₘ-[PO]ₙ]ₓ,
wherein R¹ is a C₁₂-C₁₈ alkyl group; m is 1-100; n is 1-100; and x is 1-100, and the EO and PO units are random, alternating, block, or graft;
b) Formula (II): Z—CH₂—CHZ—CH₂—[OCH₂—CHZ—CH₂]ₖ—Z,
wherein k=2-29 and each Z is independently OH or R, provided that 4 to 25 percent of Z are R, with R being:
(i) —OCH₂—CHOH—CH₂—R′, with each R′ independently
a. a long chain alkyl radical containing 6 to 20 carbon atoms, or
b. a polyoxyalkylene glycol ether radical —(CH₂—CHR″—O)ₚ—R″″, wherein each R″ is independently H, CH₃, or CH₂CH₃, p=3-20, and R′″ is a C₁-C₆ alkyl, with the average oxygen/carbon atom ratio of the radical being not greater than 0.4:1, or
(ii) —O—(CH₂—CHR″—O)ₐ—CH₂—CHOH—CH₂—O—, wherein a=6-40 and R″ is defined in (a)(ii) above, with the average oxygen:carbon ratio of —(CH₂—CHR″—O)ₐ-being not greater than 0.4:1,
wherein (i) constitutes one R and (ii) constitutes two Rs in the same or different units of Formula (II);
c) or combinations thereof.

8. The concentrated liquid rinse aid of claim 1, wherein the polyoxyalkylene condensate surfactant is a methyl-oxirane polymer with alkyl ether oxirane block surfactant.

9. The concentrated liquid rinse aid of claim 1, wherein (b) is not a Guerbet alcohol.

10. The concentrated liquid rinse aid of claim 1, wherein the concentration of (b) in the concentrated liquid rinse aid ranges from 20% w/w to 30% w/w.

11. The concentrated liquid rinse aid of claim 1, wherein (b) has an HLB value of 10 to 12.

12. The concentrated liquid rinse aid of claim 1, wherein (b) has an ethoxylation grade from 4 to 10.

13. The concentrated liquid rinse aid of claim 1, wherein (b) is a liquid at room temperature and pressure.

14. The concentrated liquid rinse aid of claim 1, wherein (b) is an ethoxylated C12-C15 isoalcohol.

15. The concentrated liquid rinse aid of claim 1, further comprising a hydrotrope.

16. The concentrated liquid rinse aid of claim 15, wherein the concentrated liquid rinse aid comprises approximately 10% w/w to approximately 20% w/w hydrotrope.

17. The concentrated liquid rinse aid of claim 1, further comprising a pH independent cationic polymer with at least one quaternary group.

18. The concentrated liquid rinse aid of claim 17, where the pH independent cationic polymer has Formula (III): —(R—O—R—N⁺R₂X—R—NH—C(═O)—NH—R—N⁺R₂X—)ₙ, wherein each R is independently a C1-C4 alkyl group, n=1-1000, and X=halide.

19. The concentrated liquid rinse aid of claim 17, wherein the pH independent cationic polymer is N,N′-bis[3-(dimethylamino)propyl]-urea polymer with 1,1′-oxybis[2-chloroethane]sold under the tradename Lugalvan P by BASF or Mirapol™ 15 by Solvay.

20. The concentrated liquid rinse aid of claim 17, wherein the concentrated liquid rinse aid comprises approximately 0.03% w/w to approximately 0.1% w/w polymer.

21. (canceled)

22. The concentrated liquid rinse aid of claim 1, wherein the concentrated liquid rinse aid does not exhibit precipitation after two weeks at 25° C.

23. A method of rinsing a hard surface in an automatic dishwashing machine, the method comprising:
a. adding one (1) party by volume of the concentrated liquid rinse aid of claim 1 to four (4) parts by volume of tap water to produce a diluted liquid rinse formulation,
b. filling the rinse aid compartment of the automatic dishwashing machine with the diluted liquid rinse formulation,
c. starting the automatic dishwashing machine.

24. The method of claim 23, wherein the hard surface is glass, ceramic, plastic, stainless steel, or any combination thereof.
